(19) United States
(12) Patent Application Publication
(10) Pub. No.: US 2026/0310720 A1
(43) Pub. Date: Oct. 8, 2026

(54) VIDEO SEARCH METHOD AND APPARATUS

(71) Applicant: SHANGHAI HODE INFORMATION TECHNOLOGY CO., LTD., Shanghai (CN)

(72) Inventors: Qiang ZHANG, Shanghai (CN); Tianjiao LI, Shanghai (CN); Fengshun XIAO, Shanghai (CN); Li LIN, Shanghai (CN); Fei CHEN, Shanghai (CN); Yansong TENG, Shanghai (CN); Kun WANG, Shanghai (CN)

(21) Appl. No.: 19/572,863

(22) Filed: Mar. 20, 2026

(30) Foreign Application Priority Data
Apr. 2, 2025 (CN) 202510413005.5

(51) Int. Cl. G06F 16/735; G06F 40/284; G06F 40/289; G06F 40/30; G06F 40/40; G10L 15/26

(52) U.S. Cl. CPC G06F 16/735; G06F 40/284; G06F 40/289; G06F 40/30; G06F 40/40; G10L 15/26

(57) ABSTRACT

The application provides a video search method and a related device/product. The method includes: obtaining a query text and determining a query type; when the query type is an information query, determining a plurality of first reference videos based on the query text and metainformation respectively associated with a plurality of videos in a preset video library, and generating a first search result; when the query type is a question query, determining a plurality of second reference videos based on the query text, the metainformation respectively associated with the plurality of videos, and text content respectively associated with the plurality of videos; and generating a second search result based on the query text and the plurality of second reference videos, wherein the second search result includes a reply text for the query text, and the text content associated with the videos are obtained by performing speech recognition on the videos.

### CROSS-REFERENCE TO RELATED APPLICATION

This application claims priority to Chinese Patent Application No. 202510413005.5, filed on Apr. 2, 2025. The entire disclosures of the above-identified application is incorporated herein by reference.

### TECHNICAL FIELD

Embodiments of the application relate to the field of Internet technologies, and in particular to a video search method and apparatus, a computer device, a computer-readable storage medium, and a computer program product.

### BACKGROUND

With development of Internet technologies, an increasing amount of information is shared in a video form, leading to a significant rise in demand for video search. However, existing video search solutions still suffer from problems such as low relevance between a search result and a search request, difficulty in adapting to diverse search requests, high computational costs, and low search efficiency, thereby affecting search experience.

It should be noted that the foregoing content is not necessarily in the conventional technology, and is not used to limit the patent protection scope of the application.

### SUMMARY

Embodiments of the application provide a video search method and apparatus, a computer device, a computer-readable storage medium, and a computer program product, to resolve or alleviate one or more of the foregoing technical problems.

According to an aspect of embodiments of the application, a video search method is provided. The method includes:
obtaining a query text, and determining a query type based on the query text, wherein the query type includes an information query or a question query;
when the query type is the information query, determining a plurality of first reference videos based on the query text and metainformation respectively associated with a plurality of videos in a preset video library, and generating a first search result, wherein the first search result includes the plurality of first reference videos; and
when the query type is the question query, determining a plurality of second reference videos based on the query text, the metainformation associated with various videos in the plurality of videos, and text content associated with various videos in the plurality of videos, and generating a second search result based on the query text and the plurality of second reference videos, wherein the second search result includes a reply text for the query text; and
the text content associated with the videos is obtained by performing a speech recognition on the videos.

Optionally, before the determining a plurality of second reference videos based on the query text, the metainformation associated with various videos in the plurality of videos, and text content associated with various videos in the plurality of videos, the video search method further includes:
determining similarities between the query text and the metainformation respectively associated with the plurality of videos; and
determining videos whose similarities are greater than a first preset threshold as the first reference videos.

Optionally, before the determining a plurality of second reference videos based on the query text, the metainformation associated with various videos in the plurality of videos, and text content associated with various videos in the plurality of videos, the method further includes:
obtaining the metainformation associated with the various videos;
inputting the metainformation into a pre-supervised fine-tuned first large language model, to extract a keyword from the metainformation by using the first large language model, and correcting the keyword;
providing a pre-configured speech recognition system with a corrected keyword as a biasing word; and
performing the speech recognition on the videos based on the biasing word by using the speech recognition system, to obtain the text content.

Optionally, the determining a plurality of second reference videos based on the query text, the metainformation associated with various videos in the plurality of videos, and text content associated with various videos in the plurality of videos includes:
enhancing the query text by using a pre-trained second large language model to obtain an enhanced query text;
processing the text content of the plurality of videos by using a pre-trained third large language model to generate digest content respectively corresponding to the plurality of videos;
performing a sparse retrieval based on the enhanced query text and the digest content respectively corresponding to the plurality of videos to obtain a first retrieval result, wherein the first retrieval result includes a video having word matching to the enhanced query text;
performing a dense retrieval based on the enhanced query text and the digest content respectively corresponding to the plurality of videos to obtain a second retrieval result, wherein the second retrieval result includes a video having semantic matching to the enhanced query text; and
determining the plurality of second reference videos based on the first retrieval result and the second retrieval result.

Optionally, the enhancing the query text by using a pre-trained second large language model to obtain an enhanced query text includes:
obtaining a historical query text and a historical video watchlist;
inputting the historical query text, the historical video watchlist, and the query text into the second large language model, to generate an expanded query word related to the query text by using the second large language model;
combining the expanded query word and the query text to obtain an expanded query text;
performing a tokenization processing on the expanded query text to obtain a plurality of subwords, and assigning a corresponding weight for each subword; and
determining the enhanced query text based on the plurality of subwords and corresponding weights thereof.

Optionally, the performing a sparse retrieval based on the enhanced query text and the digest content respectively corresponding to the plurality of videos to obtain a first retrieval result includes:
performing an information extraction on the digest content respectively corresponding to the plurality of videos by using a pre-trained fourth large language model to obtain a plurality of target elements, and constructing an inverted index based on the plurality of target elements and the digest content respectively corresponding to the plurality of videos, wherein the inverted index is used to represent digest content corresponding to each target element; and
performing the sparse retrieval based on the inverted index and the enhanced query text to obtain the first retrieval result.

Optionally, the performing a dense retrieval based on the enhanced query text and the digest content respectively corresponding to the plurality of videos to obtain a second retrieval result includes:
obtaining the metainformation respectively associated with the plurality of videos;
combining the metainformation and the digest content of each video to construct a video index set; and
inputting the video index set and the enhanced query text into a pre-trained semantic recall model, to obtain the second retrieval result by using the semantic recall model.

Optionally, the generating a second search result based on the query text and the plurality of second reference videos includes:
obtaining text content respectively associated with the plurality of second reference videos, and performing chunking processing on each text content to obtain a plurality of text content chunks, wherein each text content chunk is associated with video information, and the video information includes metainformation of a second reference video corresponding to the text content chunk and time information of the text content chunk in the corresponding second reference video;
inputting the plurality of text content chunks and the query text into a pre-trained vector retrieval model, to determine a preset quantity of text content chunks with a highest matching degree to the query text by using the vector retrieval model; and
inputting the query text, the preset quantity of text content chunks, and the video information respectively associated with the text content chunks into a pre-supervised fine-tuned fifth large language model is performed in advance, to obtain the second search result by using the fifth large language model.

According to another aspect of embodiments of the application, a video search apparatus is provided. The apparatus includes:
an obtaining module, configured to obtain a query text, and determine a query type based on the query text, wherein the query type includes an information query or a question query;
a first search module, configured to: when the query type is the information query, determine a plurality of first reference videos based on the query text and metainformation respectively associated with a plurality of videos in a preset video library, and generate a first search result, wherein the first search result includes the plurality of first reference videos; and
a second search module, configured to: when the query type is the question query, determine a plurality of second reference videos based on the query text, the metainformation associated with various videos in the plurality of videos, and text content associated with various videos in the plurality of videos, and generate a second search result based on the query text and the plurality of second reference videos, wherein the second search result includes a reply text for the query text; and
the text content associated with the videos is obtained by performing speech recognition on the videos.

According to another aspect of embodiments of the application, a computer device is provided, including:
at least one processor; and
a memory communicatively connected to the at least one processor, wherein
the memory stores instructions executable by the at least one processor, and the instructions are executed by the at least one processor to enable the at least one processor to perform the method described above.

According to another aspect of embodiments of the application, a computer-readable storage medium is provided. The computer-readable storage medium stores computer instructions, and the method described above is implemented when the computer instructions are executed by a processor.

According to another aspect of embodiments of the application, a computer program product is provided, including a computer program. The method described above is implemented when the computer program is executed by a processor.

In the embodiments of the application, the foregoing technical solutions may include the following advantages.

The query text is obtained and the query type corresponding thereto is determined. When the query type is the information query, the plurality of first reference videos are determined based on the query text and the metainformation respectively associated with the plurality of videos in the preset video library, and the first search result is generated. The first search result includes the plurality of first reference videos. When the query type is the question query, the plurality of second reference videos are determined based on the query text, the metainformation respectively associated with the plurality of videos in the preset video library, and the text content (obtained through automatic speech recognition (ASR)) respectively associated with the plurality of videos in the preset video library, and the second search result is generated based on the query text and the plurality of second reference videos. The second search result includes the reply text for the query text. It can be learned that in the embodiments of the application, video search solutions are customized for different query types. The first reference videos are quickly provided as the first search result based on the metainformation during the information query. Introducing ASR during the question query and integrating metainformation to improve understanding of video content can simultaneously control computational costs and improve the relevance between the second reference videos and the query text. Based on the second reference videos, the reply text for the query text is generated, which can provide a second search result that is more intuitive and accurate than the first search result, thereby effectively optimizing the search experience.

### BRIEF DESCRIPTION OF DRAWINGS

The accompanying drawings show examples of the embodiments and constitute a part of the specification, and together with the descriptions of the specification are used to describe example implementations of the embodiments. The illustrated embodiments are merely used for illustrative purposes and are not intended to limit the scope of the claims. In all the accompanying drawings, the same reference numerals refer to similar but not necessarily the same elements.

FIG. 1 is a schematic diagram of an operating environment of a video search method according to Embodiment 1 of the application;

FIG. 2 is a schematic flowchart of a video search method according to Embodiment 1 of the application;

FIG. 3 is a schematic flowchart of sub-steps of step S204 in FIG. 2;

FIG. 4 schematically shows first training data according to Embodiment 1 of the application;

FIG. 5 schematically shows a second search result according to Embodiment 1 of the application;

FIG. 6 is a schematic flowchart of sub-steps of step S204 in FIG. 2;

FIG. 7 is a schematic flowchart of sub-steps of step S600 in FIG. 6;

FIG. 8 schematically shows a first search result according to Embodiment 1 of the application;

FIG. 9 is a schematic flowchart of sub-steps of step S606 in FIG. 6;

FIG. 10 is a schematic flowchart of sub-steps of step S606 in FIG. 6;

FIG. 11 schematically shows a structure of a semantic recall model according to Embodiment 1 of the application;

FIG. 12 is a schematic flowchart of sub-steps of step S204 in FIG. 2;

FIG. 13 is a schematic flowchart of a video search method according to Embodiment 1 of the application;

FIG. 14 is a schematic block diagram of a video search apparatus according to Embodiment 2 of the application; and

FIG. 15 is a schematic diagram of a hardware architecture of a computer device according to Embodiment 3 of the application.

### DESCRIPTION OF EMBODIMENTS

To make the objectives, technical solutions, and advantages of the application clearer and more comprehensible, the following further describes the application in detail with reference to the accompanying drawings and embodiments. It should be understood that the specific embodiments described herein are merely used to explain the application but are not intended to limit the application. All other embodiments obtained by a person of ordinary skill in the art based on the embodiments of the application without creative efforts shall fall within the protection scope of the application.

It should be noted that the descriptions such as “first” and “second” in the embodiments of the application are merely used for description, and shall not be understood as an indication or implication of relative importance or an implicit indication of a quantity of indicated technical features. Therefore, a feature defined with “first” or “second” may explicitly or implicitly include at least one feature. In addition, the technical solutions in the embodiments may be combined with each other, provided that a person of ordinary skill in the art can implement the combination. When the combination of the technical solutions is contradictory or cannot be implemented, it should be considered that the combination of the technical solutions does not exist and does not fall within the protection scope of the application.

In the descriptions of the application, it should be understood that numerical symbols before steps do not indicate an order of performing the steps, but are merely used to facilitate description of the application and differentiation of each step, and therefore cannot be construed as a limitation on the application.

First, explanations of terms in the application are provided.

Automatic speech recognition (ASR): Automatic speech recognition is a technology converting an audio into a text.

Large language model (LLM): A large language model is a deep learning model trained on large-scale data, and can understand and generate a natural language text.

Optical character recognition (OCR): Optical character recognition is a technology that identifies a printed or handwritten text from an image and converts the printed or handwritten text into an editable text.

Frame embedding: Frame embedding is used to convert video frames into low-dimensional vectors that are easy to process and compare.

Approximate nearest neighbor (ANN): Approximate nearest neighbor accelerates a search process using an approximation method to find a data point closest to a target point.

Direct preference optimization (DPO): Direct preference optimization.

Supervised fine-tuning (SFT): Supervised fine-tuning refers to further training a pre-trained model based on a specific labeled dataset to better adapt the model to a particular task or application scenario.

Second, to help a person skilled in the art understand the technical solutions provided in the embodiments of the application, the following describes related technologies.

With development of Internet technologies, an increasing amount of information is shared in a video form, leading to a significant rise in demand for video search. However, the applicants recognize that related video search solutions still have the following defects.

(1) A text-based search solution fails to adequately index a large amount of video content, resulting in low relevance between a search result and a search request, thereby affecting search experience.

(2) An image-based search solution entails high computational costs and poor scalability. For example, mapping a query text and videos into the same space for similarity matching enables end-to-end text-to-video inference. Although the method performs well on short videos, accuracy thereof decreases and computational costs thereof increase as video duration grows. Moreover, the method requires more time to control and interpret a search result, and cannot ensure that a response is returned within a few hundred milliseconds, thus limiting large-scale deployment.

(3) It is difficult for the related video research solutions to adapt to diverse search requests, and search efficiency is low.

Therefore, an embodiment of the application provides a video search technical solution. In the technical solution: (1) Video search solutions are customized for different query types, to quickly provide videos or replies as a search result, thereby better adapting to diverse queries, saving computational costs, and effectively improving search experience. (2) For a question query, an ASR and an LLM are integrated to perform video search, wherein the ASR provides a cost-effective video understanding manner, so that the video search solution can be applied on a large scale. The LLM may correct the ASR, optimize relevance determining in video search, and quickly provide an answer based on retrieved videos, thereby significantly improving search experience. For details, see the following.

Finally, for ease of understanding, the following provides an example operating environment.

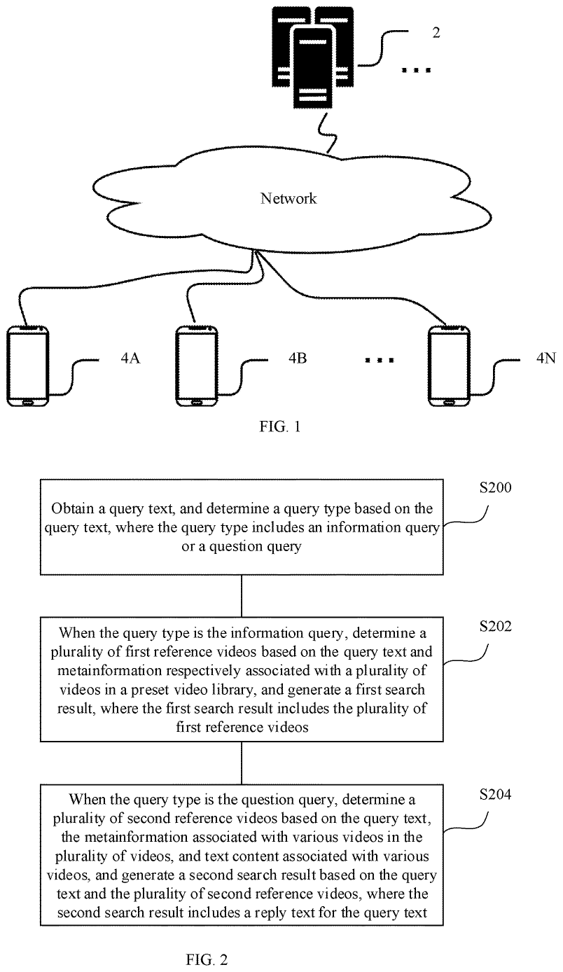

As shown in FIG. 1, an operating environment diagram includes a service platform 2 and clients (4A, 4B, . . . , and 4N).

The service platform 2 may be connected to the clients (4A, 4B, . . . , and 4N) through a network.

The service platform 2 may be a single server, a server cluster, or a cloud computing service center.

The service platform 2 may provide the clients with a video storage service, a video streaming service, a video search service, and the like.

The service platform 2 may be located in a single facility such as a data center, or distributed at different geographical locations (for example, in a plurality of facilities). The service platform 2 may provide a service through the network. The network includes various network devices, for example, a router, a switch, a multiplexer, a hub, a modem, a bridge, a repeater, a firewall, and/or a proxy device. The network may include a physical link, for example, a coaxial cable link, a twisted-pair cable link, an optical fiber link, or a combination thereof, or may include a wireless link, for example, a cellular link, a satellite link, or a Wi-Fi link.

The clients (4A, 4B, . . . , and 4N) may be configured to access content and a service of the service platform 2. The clients (4A, 4B, . . . , and 4N) may include an electronic device that carries or is connected to a display panel, for example, a mobile device, a tablet device, a laptop computer, a workstation, a virtual reality device, a game device, a digital streaming device, a vehicle terminal, a smart television, or a set-top box, or may include a virtualized computing instance. The virtualized computing instance may include a simulation of a virtual machine such as a computer system, an operating system, or a server. The computing device may load the virtual machine based on a virtual image and/or other data that defines specific software (for example, an operating system, a dedicated application program, or a server) for simulation. As requirements for different types of processing services change, different virtual machines may be loaded and/or terminated on the one or more computing devices.

The clients (4A, 4B, . . . , and 4N) may be associated with one or more client computing devices. A single client computing device may use one or more of the clients (4A, 4B, . . . , and 4N) to access the service platform 2. The clients (4A, 4B, . . . , and 4N) may travel to various locations and use different networks to access the service platform 2.

The clients (4A, 4B, . . . , and 4N) each may include an interface. The interface may include a touchpad, a touchscreen, a mouse, a keyboard, or another sensing component. For example, an input component may be configured to receive client computing device instructions. The client computing device instructions may enable the clients (4A, 4B, . . . , and 4N) to perform various operations, such as video search, video watching, and browsing a search result (for example, a reply text).

It should be noted that the foregoing device is exemplary, and in different scenarios or according to different requirements, a quantity and types of devices are adjustable.

The following describes, with reference to a plurality of embodiments, the technical solutions of the application by using the service platform 2 as an execution body. It should be noted that these embodiments may be implemented in a plurality of different forms, and should not be construed as being limited to the embodiments described herein.

### Embodiment 1

FIG. 2 is a schematic flowchart of a video search method according to Embodiment 1 of the application.

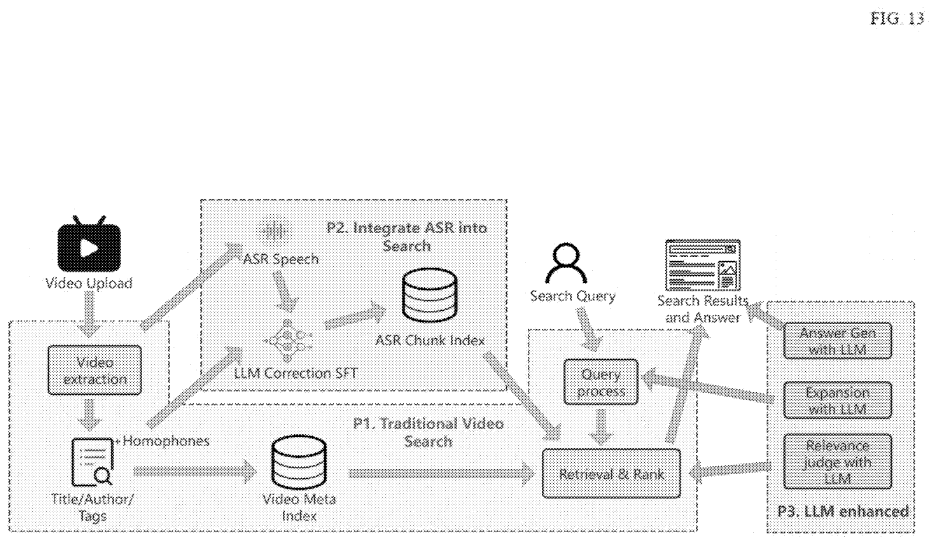

As shown in FIG. 2 and FIG. 13, the video search method may include steps S200 to S204.

Step S200: Obtain a query text, and determine a query type based on the query text, wherein the query type includes an information query or a question query.

Step S202: When the query type is the information query, determine a plurality of first reference videos based on the query text and metainformation respectively associated with a plurality of videos in a preset video library, and generate a first search result, wherein the first search result includes the plurality of first reference videos.

Step S204: When the query type is the question query, determine a plurality of second reference videos based on the query text, the metainformation associated with various videos in the plurality of videos, and text content associated with various videos in the plurality of videos, and generate a second search result based on the query text and the plurality of second reference videos, wherein the second search result includes a reply text for the query text. The text content associated with the videos is obtained by performing a speech recognition on the videos.

According to the video search method provided in the embodiment, the query text is obtained and the query type corresponding thereto is determined. When the query type is the information query, the plurality of first reference videos are determined based on the query text and the metainformation respectively associated with the plurality of videos in the preset video library, and the first search result is generated. The first search result includes the plurality of first reference videos. When the query type is the question query, the plurality of second reference videos are determined based on the query text, the metainformation respectively associated with the plurality of videos in the preset video library, and the text content (obtained through automatic speech recognition (ASR)) respectively associated with the plurality of videos in the preset video library, and the second search result is generated based on the query text and the plurality of second reference videos. The second search result includes the reply text for the query text. It can be learned that in the embodiments of the application, video search solutions are customized for different query types. The first reference videos are quickly provided as the first search result based on the metainformation during the information query. Introducing ASR during the question query and integrating metainformation to improve understanding of video content can simultaneously control computational costs and improve the relevance between the second reference videos and the query text. Based on the second reference videos, the reply text for the query text is generated, which can provide a second search result that is more intuitive and accurate than the first search result, thereby effectively optimizing the search experience.

With reference to FIG. 2, steps in steps S200 to S204 and other optional steps are described in detail below.

Sten S200: Obtain a query text, and determine a query type based on the query text, wherein the query type includes an information query or a question query.

A client may receive, through an interface (for example, a touchscreen or a keyboard), the query text (query), for example, “iPhone 16” or “Difference between iPhone 16 and 16pro”, input by a client computing device. A search request may be generated based on the query text and sent to the service platform 2. After receiving the search request, the service platform 2 may obtain the query text by parsing the search request, and determine a corresponding query type based on the query text. Query types may include the information query and the question query. For the information query, a query input may be a keyword or a phrase, a query target may be a related document, a webpage, or the like. The client computing device tends to obtain information by browsing related documents or the webpages. For the question query, a query input may be a complete question or a natural language, and a query target may be an answer corresponding to the question. The client computing device tends to obtain a direct answer without further reading a large amount of documents. For example, a query text such as “iPhone 16” or “Hongshan Zoo” tends to indicate that the client computing device is looking for content (for example, a video) related to iPhone 16 or HongShan Zoo. Therefore, a type of such a text may be determined as the information query. Correspondingly, a searched related video may be directly pushed to the client. A query text of “Difference between iPhone 16 and 16pro” more tends to indicate that the client computing device wants to directly obtain an answer of the specific question. In this case, displaying the answer for the query text can better meet an actual requirement compared to displaying the related video, thereby improving search experience. Therefore, in the embodiment of the application, the query type is accurately recognized from the query text, and corresponding video search solutions are customized for different query types, to adapt to diverse queries, thereby improving search satisfaction. For example, a pre-developed four-layer lightweight BERT model may be used to accurately recognize the query type. In actual deployment, a FastText model may be further used to distill a result of the BERT model to achieve a faster response and reduce required deployment resources. In actual application, the model may have recognition accuracy of more than 90%, and occupies relatively few computing resources.

Sten S202: When the query type is the information query, determine a plurality of first reference videos based on the query text and metainformation respectively associated with a plurality of videos in a preset video library, and generate a first search result, wherein the first search result includes the plurality of first reference videos.

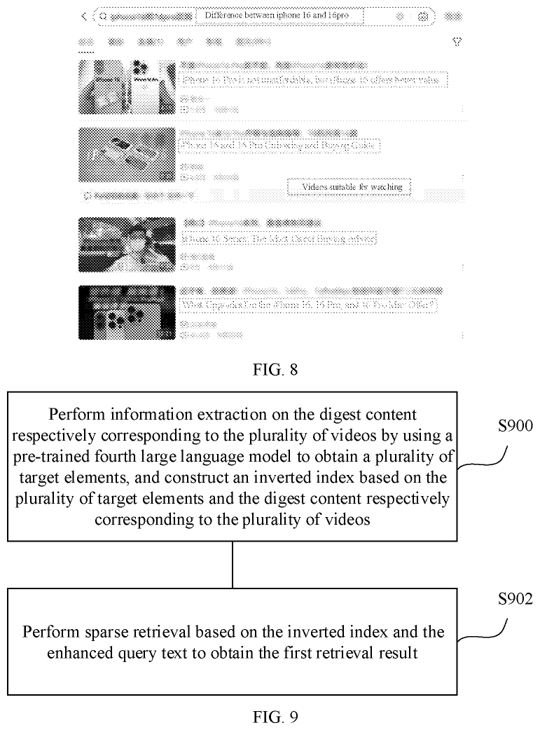

The preset video library may be a database that is pre-maintained in the service platform and that is used for video storage, and may include a plurality of videos. Each video may be associated with metainformation. The metainformation of the video may include but is not limited to a video title, video description, a video tag, a release date, and/or an author. When the query type is the information query, a similarity between the query text and the metainformation of each video in the preset video library may be calculated, a plurality of videos with high similarities are obtained from the plurality of videos as the first reference videos, and the first search result is generated. The service platform may send the first search result to the client, and display the first search result by using the client. As shown in FIG. 8, the first search result may be a video list, and the video list corresponds to the plurality of first reference videos.

In the embodiment, related videos are quickly obtained and returned based on the similarities between the query text and the metainformation of the videos, thereby improving information search efficiency.

In an optional embodiment, step S202 may include: determining similarities between the query text and the metainformation respectively associated with the plurality of videos; and determining videos whose similarities are greater than a first preset threshold as the first reference videos.

For example, video titles, author identities (ID), video tags, and the like may be obtained from the metainformation of the videos, similarities between the query text and all of the video titles, the author identities, and the video tags are calculated, and the videos whose similarities are greater than the first preset threshold are determined as the first reference videos.

In the embodiment, the videos with high relevance may be accurately selected as a search result by calculating the similarities between the query text and the metainformation, thereby improving search experience.

Sten S204: When the query type is the question query, determine a plurality of second reference videos based on the query text, the metainformation associated with various videos in the plurality of videos, and text content associated with various videos in the plurality of videos, and generate a second search result based on the query text and the plurality of second reference videos, wherein the second search result includes a reply text for the query text, and the text content associated with the videos is obtained by performing a speech recognition on the videos.

The text content associated with the videos may be obtained by performing the speech recognition (ASR) on the videos. Specifically, a pre-configured speech recognition system may be used to extract speech from audio tracks of the videos and convert the speech into the text content suitable for analysis, thereby improving understanding of content of the videos and making the content of the videos easier to index, search, and analyze. In actual application, the text content generated through ASR may include recognition errors such as homophones (for example, “yurao” for [symbol] and [symbol] , similar-sound words (for example, “jinhaishi” for [symbol] and “jinghaishi” for [symbol] ), and entities (for example, person names, place names, and brand names). These errors may lead to misinterpretation of video content when the text content generated through ASR is applied to video search, directly affecting search accuracy. Therefore, to improve search accuracy, a speech recognition process may be optimized to obtain high-quality text content. The following provides an exemplary solution.

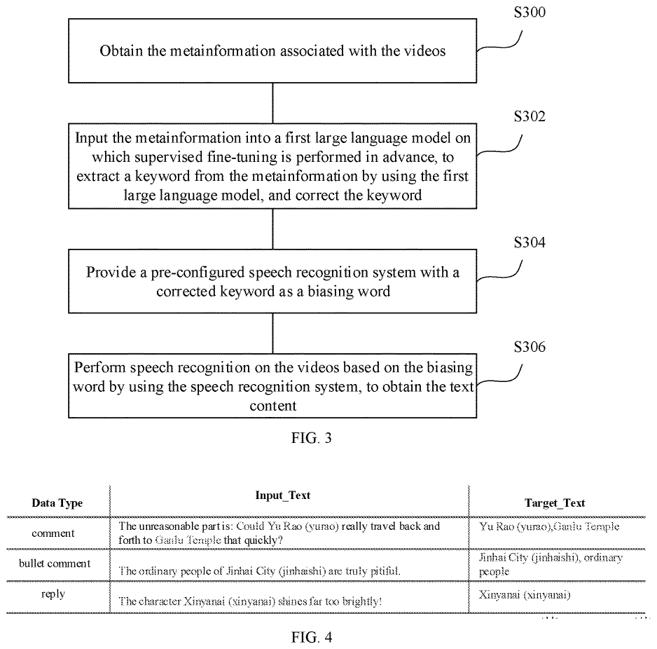

In an optional embodiment, as shown in FIG. 3, step S204 may include:

Step S300: Obtain the metainformation associated with the various videos.

Step S302: Input the metainformation into a pre-supervised fine-tuned first large language model, to extract a keyword from the metainformation by using the first large language model, and correct the keyword.

Step S304: Provide a pre-configured speech recognition system with a corrected keyword as a biasing word.

Step S306: Perform the speech recognition on the videos based on the biasing word by using the speech recognition system, to obtain the text content.

For example, the metainformation associated with the videos may be obtained, and the metainformation is input into the pre-supervised fine-tuned first large language model, to extract the keyword, for example, the video title, the video tag, and the video description, from the metainformation by using the first large language model, and an error in the keyword is recognized and corrected. The error may include a homophone, a similar-sound word, an entity, or the like. Correction may include replacing erroneous homophones, similar-sound words, and entities based on a pre-configured standard lexicon and standard entity database. It should be noted that the terms “first”, “second”, and the like in the embodiment of the application are only used for identification, but are not used as limitations. For example, the first large language model, the second large language model, and the third large language model may be a same large language model, or may be different large language models, or versions obtained after different supervised fine-tuning is performed on a same large language model.

After the keyword is extracted and corrected by using the LLM, the corrected keyword may be provided to the pre-configured speech recognition system as the biasing word. The biasing word may be used to guide or optimize an output of the speech recognition system, thereby improving recognition accuracy. The speech recognition is performed on the videos by using the speech recognition system under the guidance of the biasing word, to obtain high-quality text content. For example, the biasing word may be “iPhone”, and the speech recognition system may incorrectly recognize “iPhone” in the audio as “eye phone”. Based on the biasing word, the speech recognition system may more tend to select correct “iPhone” for outputting. For example, the speech recognition system may implement context biasing with reference to a WFST beam search algorithm, thereby improving accuracy of the text content. The algorithm may be represented as follows:

$${y}^{*} = {arg max}_{y} log P ( y \vert x ) + λ log {P}_{C} ( y ) ;$$

Wherein, x is an acoustic feature (extracted from an audio track of a video), y is the text content recognized through ASR, log PC(y) is a context score derived from the biasing word, log P(y|x) is a score assigned by the speech recognition system to corresponding text content y based on the given acoustic feature x, λ is a tunable hyperparameter, and y* represents a final score of the text content generated through ASR. A higher final score indicates higher accuracy of the text content.

In the embodiment, the keyword is extracted and corrected by the pre-supervised fine-tuned LLM, and is provided to the speech recognition system as the biasing word, to improve accuracy of speech recognition through context biasing, and generate high-quality text content. In particular, high accuracy can be ensured when the homophones, the similar-sound words, and the entities are recognized.

Supervised fine-tuning may be performed on the first large language model based on first training data. The first training data may be shown in FIG. 4. For example, training data pairs may be constructed based on interactive data (for example, comments, bullet comments, and replies) of the videos, an input Input—text may be from the interactive data (for example, “The unreasonable part is: Could Yu Rao really travel back and forth to Ganlu Temple that quickly?”), and an output may be a possible keyword, for example, “Yu Rao” or “Ganlu Temple”. These data pairs are verified by using a machine or manually to ensure accuracy, and whether the output includes no erroneous character is verified. If there is an erroneous character, an incorrect keyword is replaced with a correct homophone, similar-sound word, or entity based on a possible pinyin variant, entity, or the like. For example, in FIG. 4, [symbol] yurao is replaced with [symbol] yurao. The supervised fine-tuning is performed on the large language model (LLM) based on the constructed first training data, so that the supervised fine-tuned LLM can mine and correct the keyword based on the comments, the bullet comments, the replies, and the text content generated through ASR.

In some embodiments, the supervised fine-tuning (SFT) may alternatively be performed on the LLM based on the first training data first, and the audio of the videos is converted into original text content through ASR. The original text content may include errors such as homophones, similar-sound words, and entities. The supervised fine-tuned LLM is directly used to correct the original text content to obtain text content with higher quality. In actual application, the solution performs worse than the previous one, that is, first using the LLM to extract the keyword and then performing context biasing, on metrics such as keyword recall, accuracy, and generalizability. Therefore, the previous solution may be preferred for improving text content quality and further optimizing search accuracy.

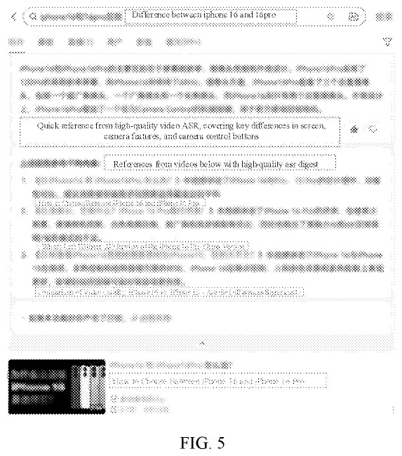

The plurality of embodiments described above illustrate how to obtain high-quality text content. Based on the query text and with reference to the metainformation and the text content of the videos, video search may be performed on a premise of deep understanding of the videos, to obtain the plurality of second reference videos with high relevance. The second search result may be generated based on the query text and the plurality of second reference videos. The second search result may include a reply text for the query text, and may further include related information of the second reference videos (for example, video titles and video descriptions), as shown in FIG. 5.

In the embodiment, the ASR technology is introduced to enhance accuracy and relevance of video search in content understanding. Resource and computational demands of ASR in the videos are less than 10% of those required for OCR or frame embedding, enabling large-scale application. This is particularly beneficial for scientific and educational videos that include a large amount of text content. Integrating ASR into video search can improve relevance of the search result and improve search satisfaction. Performing video search based on the query text and with reference to the metainformation and the text content can obtain the second reference videos with improved relevance, thereby providing an effective answer for the query text.

The following further describes step S204 with reference to a plurality of exemplary solutions.

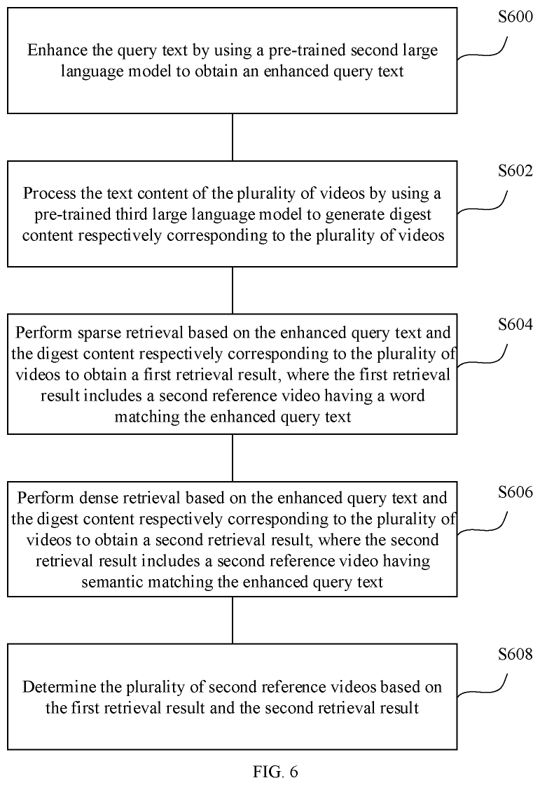

In an optional embodiment, as shown in FIG. 6, step S204 may include:

Step S600: Enhance the query text by using a pre-trained second large language model to obtain an enhanced query text.

Step S602: Process the text content of the plurality of videos by using a pre-trained third large language model to generate digest content respectively corresponding to the plurality of videos.

Step S604: Perform a sparse retrieval based on the enhanced query text and the digest content respectively corresponding to the plurality of videos to obtain a first retrieval result, wherein the first retrieval result includes a video having word matching to the enhanced query text.

Step S606: Perform a dense retrieval based on the enhanced query text and the digest content respectively corresponding to the plurality of videos to obtain a second retrieval result, wherein the second retrieval result includes a video having semantic matching to the enhanced query text.

Step S608: Determine the plurality of second reference videos based on the first retrieval result and the second retrieval result.

For example, the query text (query) may be enhanced by using the pre-trained second large language model (LLM), to obtain the enhanced query text. Then, the enhanced query text is matched with the videos to retrieve more relevant and high-quality second reference videos, thereby improving the search result and providing a high-quality reference for subsequent answer generation.

The following provides an exemplary solution.

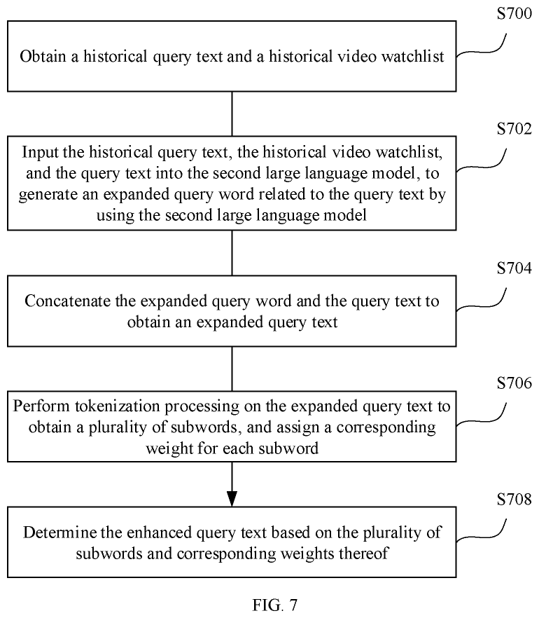

In an optional embodiment, as shown in FIG. 7, step S600 may include:

Step S700: Obtain a historical query text and a historical video watchlist.

Step S702: Input the historical query text, the historical video watchlist, and the query text into the second large language model, to generate an expanded query word related to the query text by using the second large language model.

Step S704: Combine the expanded query word and the query text to obtain an expanded query text.

Step S706: Perform a tokenization processing on the expanded query text to obtain a plurality of subwords, and assign a corresponding weight for each subword.

Step S708: Determine the enhanced query text based on the plurality of subwords and corresponding weights thereof.

For example, the historical query text and the historical video watchlist of the client computing device may be obtained. It should be noted that data in the embodiment of the application is obtained in compliance with regulations and with the consent of the client computing device, and undergoes anonymization processing. The historical query text and the historical video watchlist may be used as prompt words to enhance an understanding capability of the large language model. The prompt words are input together with the query text into the second large language model. Optionally, a manually crafted example may be further input into the second large language model to guide the LLM in generating the expanded query word related to the query text. For example, the query text may be “Beijing flowers”, and the expanded query word generated by the LLM may be “capital”, “flowers”, or the like. The expanded query word and the query text are combined to obtain the expanded query text. It should be noted that combination in the embodiment of the application may be simple concatenation, or may be regenerating a new text. The expanded query text is tokenized by using a plurality of tokenizers such as Jieba, HanLP, and Spacy to obtain the plurality of subwords, and each subword is assigned with a corresponding weight. The enhanced query text may be generated based on the plurality of subwords and the weights respectively corresponding thereto. Due to performance differences among the tokenizers, a query text with a large tokenization difference among the plurality of tokenizers may be evaluated and corrected by using the LLM. For example, some tokenizers do not include domain-specific technical terms, leading to splitting of the technical terms into individual characters, or to no tokenization being performed, thereby causing tokenization results to conflict with those of other tokenizers. By optimizing such query texts through LLM, the accuracy can be increased from 87.5% to 95.5%. The data is obtained by evaluating 160 million randomly selected query texts, and a term weight is increased from 89.75% to 92.75%.

In the embodiment, the query text is expanded by using the LLM and tokenization processing is performed, so that comprehensiveness of the query text can be improved, thereby improving the relevance and accuracy of video search.

In some embodiments, the expanded query text may alternatively be used directly as the enhanced query text for video retrieval, thereby balancing search efficiency and search accuracy.

The LLM may be used to enhance understanding of the query text, and may also be used to enhance the text content generated through ASR. Because the text content generated through ASR is unofficial and has low information density and high noise, effective digest content needs to be generated to improve search experience. Displaying the digest content of the videos in the search result can increase search confidence and interactivity. For example, video subjects, such as video titles or comment high-frequency words, may be obtained from the metainformation and the interactive data of the videos corresponding to the text content. The video subjects and the text content are input into the pre-trained LLM together, to generate high-quality digest content. Further, for a long text content, a two-stage generation approach can be adopted, for example, the text content is segmented, and digest content is separately extracted for each segment by using the LLM. These pieces of digest content are integrated together and re-input into the LLM to generate final digest content. In the embodiment, high-quality digest content may be obtained by using the LLM for video retrieval, which can reduce interference caused by noise to video search and improve search accuracy.

After the enhanced query text and the digest content of each video are obtained by using the LLM, the related videos (second reference videos) may be recalled in a search engine in combination with sparse retrieval and dense retrieval. The sparse retrieval can ensure recall accuracy, while the dense retrieval can explore more semantically relevant videos. Video retrieval based on high-quality digest content can achieve real-time and accurate recall. The following provides an exemplary solution.

In an optional embodiment, as shown in FIG. 9, step S606 may include: Step S900: Perform an information extraction on the digest content respectively corresponding to the plurality of videos by using a pre-trained fourth large language model to obtain a plurality of target elements, and construct an inverted index based on the plurality of target elements and the digest content respectively corresponding to the plurality of videos. The inverted index is used to represent digest content corresponding to each target element.

Step S902: Perform the sparse retrieval based on the inverted index and the enhanced query text to obtain the first retrieval result.

For example, the target elements (core elements), such as a subject and a time, may be extracted from the digest content by using a BERT-based UIE. Which digest content each target element appears in is recorded to construct the inverted index. The sparse retrieval is performed based on the inverted index and the enhanced query text to obtain the first retrieval result. The first retrieval result may include a second reference video having word matching to the enhanced query text. Different from ANN, the method does not require index reconstruction when facing newly added videos, thereby ensuring that newly published videos can also be quickly recalled, while providing stronger explainability for rare retrieval.

In the embodiment, real-time performance and accuracy of video retrieval are improved by combining the LLM and sparse retrieval.

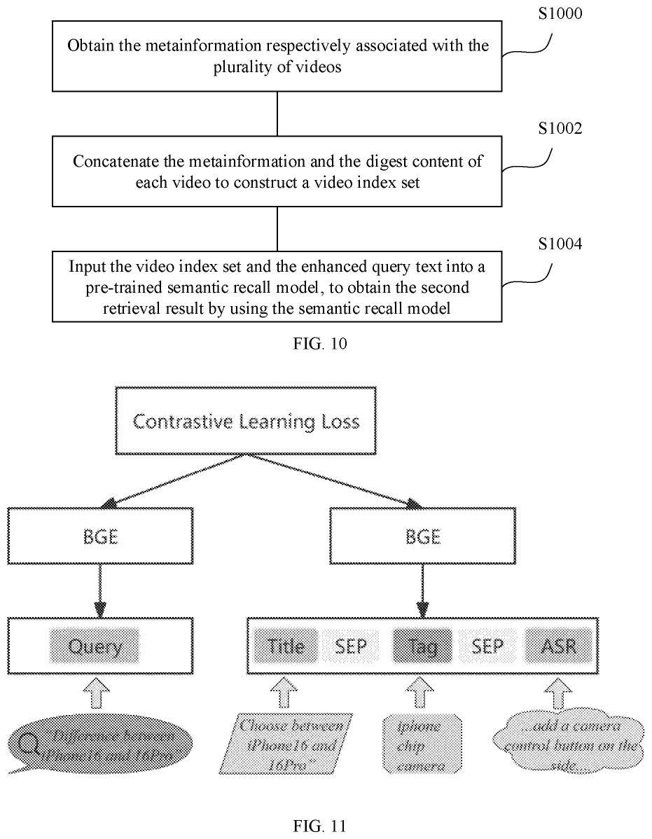

In an optional embodiment, as shown in FIG. 10, step S606 may include:

Step S1000: Obtain the metainformation respectively associated with the plurality of videos.

Step S1002: Combine the metainformation and the digest content of each video to construct a video index set.

Step S1004: Input the video index set and the enhanced query text into a pre-trained semantic recall model, to obtain the second retrieval result by using the semantic recall model.

For example, the metainformation of the videos, for example, the video titles and the video tags, may be obtained. The digest content, the video titles, and the video tags are combined to construct the video index set. The video index set is input into the pre-trained semantic recall model to obtain the second retrieval result. The second retrieval result may include a second reference video having semantic matching to the query text.

In the embodiment, sufficient video indexes are constructed with reference to the digest content, the video titles, and the video tags of the videos, and comprehensive semantic recall may be performed based on the enhanced query text, thereby improving search accuracy and relevance.

The semantic recall model may be obtained by training a pre-trained BGE model by using a comparison learning framework, and a contrastive learning loss formula may be represented as follows:

$${l}_{i} = - log \frac{{e}^{sim ( {h}_{i} , {h}_{i}^{+} ) / γ}}{{\sum }_{j = 1}^{N} {e}^{sim ( {h}_{i} , {h}_{j}^{+} ) / γ}} ;$$

hi and hi⁺ respectively represent a vector of the enhanced query text and a vector of a video index, which are output by the BGE model. N represents a size of a training batch. A structure of the model is shown in FIG. 11.

In some embodiments, a set of search queries with the highest video engagement can be mined into the model to enhance a model performance.

In some embodiments, the LLM may be trained to score relevance between each second reference video and the query text, and perform ranking. For example, a client computing device search interaction log may be first mined to collect samples. The samples are reference videos corresponding to the historical query text. Alternatively, samples may be selected by using a prompt based on a semantic understanding capability of the LLM. Different from a quantity of taps and watching duration of the client computing device, selection is performed based on whether the reference videos contribute to generating the reply text. In actual application, there is a client computing device behavior deviation. The watching duration and the quantity of taps are generally dominated by hot or attractive videos, and videos based on knowledge and experience may not perform well in terms of the watching duration and the quantity of taps. Therefore, the prompt may be constructed based on contribution to the reply text to guide the LLM in selecting more suitable samples. Model training is performed based on the samples to obtain a basic model of a first stage. The basic model may then be distilled to optimize the model performance. For example, a performance optimization may be performed on the basic model by using a MiniiRBT Chinese pre-training model and FastTokenizer to obtain a final model. In relevance evaluation, duration for evaluating 300 video clips may be reduced from 90 milliseconds to 23 milliseconds.

Based on the first retrieval result and the second retrieval result, second reference videos combining word matching and semantic matching may be combined to obtain the plurality of second reference videos. Based on the text content of the plurality of second reference videos and the query text, a required answer can be generated by using the LLM. The following provides an exemplary solution.

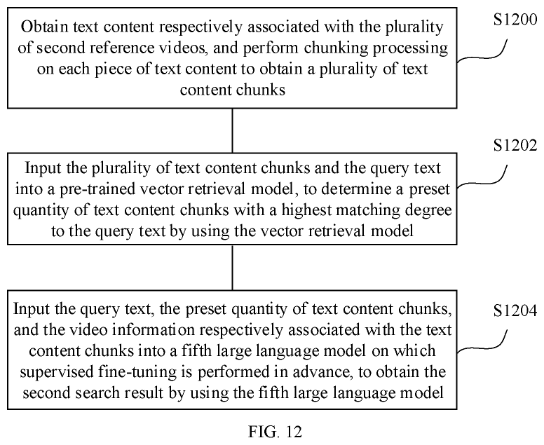

In an optional embodiment, as shown in FIG. 12, step S204 may include:

Step S1200: Obtain text content respectively associated with the plurality of second reference videos, and perform a chunking processing on each text content to obtain a plurality of text content chunks. Each text content chunk is associated with video information, and the video information includes metainformation of a second reference video corresponding to the text content chunk and time information of the text content chunk in the corresponding second reference video.

Step S1202: Input the plurality of text content chunks and the query text into a pre-trained vector retrieval model, to determine a preset quantity of text content chunks with a highest matching degree to the query text by using the vector retrieval model.

Step S1204: Input the query text, the preset quantity of text content chunks, and the video information respectively associated with the text content chunks into a pre-supervised fine-tuned fifth large language model is performed in advance, to obtain the second search result by using the fifth large language model.

For example, after the plurality of second reference videos returned by the search engine are obtained, the first K videos most relevant to the query text (wherein K may be any value, for example, 5 to 10, specifically depending on a threshold of the relevance score) may be obtained based on the relevance score of each second reference video provided by the search engine, and the text content of these videos may be obtained from a storage. Then, each text content is segmented into a plurality of text content chunks. Each text content chunk may include S Chinese characters, wherein Sϵ{64, 128, 256, 512, 1024}. Each text content chunk may be associated with video information, and the video information may include the metainformation (for example, a video title) of a corresponding second reference video and time information (for example, an interval in the video) of the text content chunk in the corresponding second reference video. N text content chunks most related to the query text may be recognized by using the pre-trained vector retrieval model, to ensure a context window length of N*S≤LLM (for example, 3200). Experiments show that using S=256 and N=12 in the LLM prompt can achieve optimal coherence and diversity. Finally, the query text, and the N text content chunks and the video information respectively associated therewith are combined to form a specific prompt. The prompt is input into the supervised fine-tuned LLM based on general dialogue data and search-based question guidance, to generate the final answer. In actual semantics, a plurality of prompts with similar meanings but different formats can be used to enhance diversity of answers.

In the embodiment, the metainformation of the videos is introduced to provide more structured information for a combined text content chunk, so that the LLM can better understand the search result.

The vector retrieval model can be obtained by performing supervised fine-tuning on a BGE-base-zh-v1.5 model using pre-configured, high-quality data pairs of the query text and the text content chunks. To generate the data pairs, the query text and each text content chunk can be input into the LLM together, processed through the same prompt, and evaluated using an automatic scoring system to assess quality of an answer of the LLM. Higher answer quality can indicate stronger relevance between the query text and the text content chunk.

Finally, the service platform may send the second search result to the client, and the client may display the second search result through an interface and provide an interactive option, for example: likes or dislikes for the answer. Data fed back by the client computing device is collected for the reply text for supervised fine-tuning of the LLM, or a DPO algorithm is applied to learn a preference of the client computing device. The following provides some exemplary solutions.

In some embodiments, to reduce inference costs of the LLM, a prediction model may be established based on the likes and dislikes data for the answer. When the LLM generates the answer, the prediction model may be used to: rank the generated answer against a cached answer, ultimately outputting an answer most likely preferred by the client computing device.

In some embodiments, for the answer provided by the search engine, the client computing device may give likes or dislikes through a selection control. The data is collected to indicate satisfaction of the client computing device with the answer. For an answer wherein the likes or dislikes ratio exceeds a set threshold, the answer along with the likes/dislikes data may be re-input into the LLM as a prompt to guide the LLM in regenerating a better answer. The data may be further added to the supervised fine-tuning training data of the LLM for data augmentation.

In some embodiments, a good answer often depends on text content the answer references. Therefore, the corresponding text content may be added to the prompt of the vector retrieval model, thereby optimizing training of the vector retrieval model.

In some embodiments, to enhance a capability of the model to follow instructions and align with human preferences, high-confidence likes and dislikes data can be selected as positive and negative samples, and the DPO algorithm is used to maximize likelihood differences therebetween. The algorithm may be represented as follows:

$${ℒ}_{DPO} ( {π}_{θ} ; {π}_{ref} ) = - {\text{?}}_{( x , {y}_{l} , {y}_{d} ) ∼ 𝒟} [ log σ ( β log \frac{{π}_{θ} ( {y}_{l} \vert x )}{{π}_{ref} ( {y}_{l} \vert x )} - β log \frac{{π}_{θ} ( {y}_{d} \vert x )}{{π}_{ref} ( {y}_{d} \vert x )} ) ] ;$$

π_{ref} is the fine-tuned LLM model, π_{θ} is an optimized model, x is a question, y₁ is a preferred answer (likes), y_{d} is a dispreferred answer, D is a DPO training set, and β is a hyperparameter.

### Embodiment 2

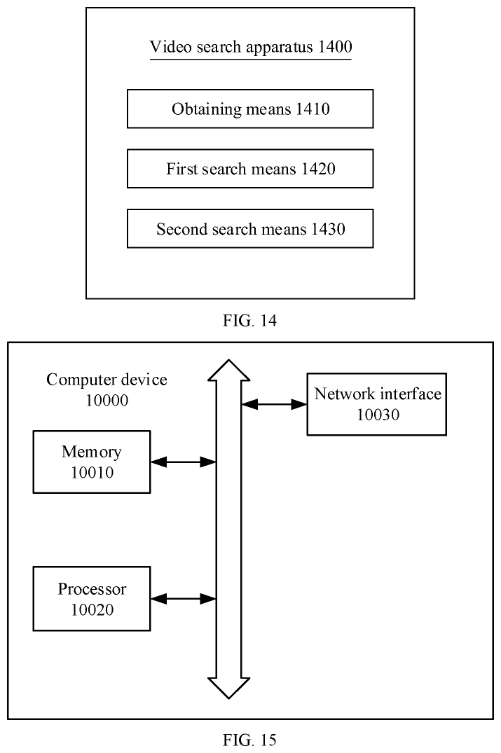

FIG. 14 is a schematic block diagram of a video search apparatus according to Embodiment 2 of the application. The apparatus may be divided into one or more program module. The one or more program modules are stored in a storage medium and executed by one or more processors, so as to complete the embodiment of the application. The program module in the embodiment of the application is a series of computer program instruction segments that can be used to complete a specific function. The following specifically describes a function of each program module in the embodiment. As shown in FIG. 14, the apparatus 1400 may include an obtaining module 1410, a first search module 1420, and a second search module 1430.

The obtaining module 1410 is configured to obtain a query text, and determine a query type based on the query text, wherein the query type includes an information query or a question query.

The first search module 1420 is configured to: when the query type is the information query, determine a plurality of first reference videos based on the query text and metainformation respectively associated with a plurality of videos in a preset video library, and generate a first search result, wherein the first search result includes the plurality of first reference videos.

The second search module 1430 is configured to: when the query type is the question query, determine a plurality of second reference videos based on the query text, the metainformation associated with various videos in the plurality of videos, and text content associated with various videos in the plurality of videos, and generate a second search result based on the query text and the plurality of second reference videos, wherein the second search result includes a reply text for the query text.

The text content associated with the videos is obtained by performing speech recognition on the videos.

In an optional embodiment, the first search module 1420 is configured is further configured to:
determine similarities between the query text and the metainformation respectively associated with the plurality of videos; and
determine videos whose similarities are greater than a first preset threshold as the first reference videos.

In an optional embodiment, before the determining a plurality of second reference videos based on the query text, the metainformation associated with various videos in the plurality of videos, and text content associated with various videos in the plurality of videos, the apparatus 1400 is further configured to:
obtain the metainformation associated with the videos;
input the metainformation into a pre-supervised fine-tuned first large language model, to extract a keyword from the metainformation by using the first large language model, and correcting the keyword;
provide a pre-configured speech recognition system with a corrected keyword as a biasing word; and
perform the speech recognition on the videos based on the biasing word by using the speech recognition system, to obtain the text content.

In an optional embodiment, the second search module 1430 is further configured to:
enhance the query text by using a pre-trained second large language model to obtain an enhanced query text;
process the text content of the plurality of videos by using a pre-trained third large language model to generate digest content respectively corresponding to the plurality of videos;
perform a sparse retrieval based on the enhanced query text and the digest content respectively corresponding to the plurality of videos to obtain a first retrieval result, wherein the first retrieval result includes a video having word matching to the enhanced query text;
perform a dense retrieval based on the enhanced query text and the digest content respectively corresponding to the plurality of videos to obtain a second retrieval result, wherein the second retrieval result includes a video having semantic matching to the enhanced query text; and
determine the plurality of second reference videos based on the first retrieval result and the second retrieval result.

In an optional embodiment, the second search module 1430 is further configured to:
obtain a historical query text and a historical video watchlist;
input the historical query text, the historical video watchlist, and the query text into the second large language model, to generate an expanded query word related to the query text by using the second large language model;
combine the expanded query word and the query text to obtain an expanded query text;
perform a tokenization processing on the expanded query text to obtain a plurality of subwords, and assigning a corresponding weight for each subword; and
determine the enhanced query text based on the plurality of subwords and corresponding weights thereof.

In an optional embodiment, the second search module 1430 is further configured to:
perform an information extraction on the digest content respectively corresponding to the plurality of videos by using a pre-trained fourth large language model to obtain a plurality of target elements, and constructing an inverted index based on the plurality of target elements and the digest content respectively corresponding to the plurality of videos, wherein the inverted index is used to represent digest content corresponding to each target element; and
perform the sparse retrieval based on the inverted index and the enhanced query text to obtain the first retrieval result.

In an optional embodiment, the second search module 1430 is further configured to:
obtain the metainformation associated with the various videos;
combine the metainformation and the digest content of each video to construct a video index set; and
input the video index set and the enhanced query text into a pre-trained semantic recall model, to obtain the second retrieval result by using the semantic recall model.

In an optional embodiment, the second search module 1430 is further configured to:
obtain text content respectively associated with the plurality of second reference videos, and performing a chunking processing on each text content to obtain a plurality of text content chunks, wherein each text content chunk is associated with video information, and the video information includes metainformation of a second reference video corresponding to the text content chunk and time information of the text content chunk in the corresponding second reference video;
input the plurality of text content chunks and the query text into a pre-trained vector retrieval model, to determine a preset quantity of text content chunks with a highest matching degree to the query text by using the vector retrieval model; and
input the query text, the preset quantity of text content chunks, and the video information respectively associated with the text content chunks into a pre-supervised fine-tuned fifth large language model is performed in advance, to obtain the second search result by using the fifth large language model.

### Embodiment 3

FIG. 15 is a schematic diagram of a hardware architecture of a computer device 10000 suitable for implementing a video search method according to Embodiment 3 of the application. In some embodiments, the computer device 10000 may be a terminal device such as a smartphone, a wearable device, a tablet computer, a personal computer, a vehicle-mounted terminal, a game console, a virtual device, a workbench, a digital assistant, a set-top box, or a robot. In some other embodiments, the computer device 10000 may be a rack server, a blade server, a tower server, a cabinet server (including an independent server, or a server cluster including a plurality of servers), or the like. As shown in FIG. 15, the computer device 10000 at least includes, but is not limited to, a memory 10010, a processor 10020, and a network interface 10030 that can be communicatively connected to each other by using a system bus.

The memory 10010 includes at least one type of computer-readable storage medium. The readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, or the like. In some embodiments, the memory 10010 may be an internal storage module of the computer device 10000, for example, a hard disk or an internal memory of the computer device 10000. In some other embodiments, the memory 10010 may alternatively be an external storage device of the computer device 10000, for example, a plug-in hard disk, a smart media card (SMC), a secure digital (SD) card, or a flash card that is disposed on the computer device 10000. Certainly, the memory 10010 may alternatively include both an internal storage module of the computer device 10000 and an external storage device of the computer device 10000. In the embodiment, the memory 10010 is usually configured to store an operating system and various types of application software that are installed on the computer device 10000, for example, program code of the video search method. In addition, the memory 10010 may be further configured to temporarily store various types of data that have been output or are to be output.

In some embodiments, the processor 10020 may be a central processing unit (CPU), a controller, a microcontroller, a microprocessor, or another data processing chip. The processor 10020 is usually configured to control an overall operation of the computer device 10000, for example, perform control and processing related to data exchange or communication performed by the computer device 10000. In the embodiment, the processor 10020 is configured to run program code stored in the memory 10010 or process data.

The network interface 10030 may include a wireless network interface or a wired network interface, and the network interface 10030 is usually configured to establish a communication link between the computer device 10000 and another computer device. For example, the network interface 10030 is configured to: connect the computer device 10000 to an external terminal by using a network, and establish a data transmission channel, a communication link, and the like between the computer device 10000 and the external terminal. The network may be a wireless or wired network such as an Intranet, the Internet, a global system for mobile communications (GSM), a wideband code division multiple access (WCDMA), a 4G network, a 5G network, Bluetooth, or Wi-Fi.

It should be noted that FIG. 15 shows only a computer device with the components 10010-10030. However, it should be understood that implementation of all the shown components is not required, and more or fewer components may alternatively be implemented.

In the embodiment, the video search method stored in the memory 10010 may be further divided into one or more program module to be executed by one or more processors (the processor 10020), so as to complete the embodiment of the application.

### Embodiment 4

An embodiment of the application further provides a computer-readable storage medium. The computer-readable storage medium stores a computer program therein. When the computer program is executed by a processor, the steps of the video search method in the embodiments are implemented.

In the embodiment, the computer-readable storage medium includes a flash memory, a hard disk, a multimedia card, a card-type memory (for example, an SD memory or a DX memory), a random access memory (RAM), a static random access memory (SRAM), a read-only memory (ROM), an electrically erasable programmable read-only memory (EEPROM), a programmable read-only memory (PROM), a magnetic memory, a magnetic disk, an optical disc, and the like. In some embodiments, the computer-readable storage medium may be an internal storage unit of a computer device, for example, a hard disk or a memory of the computer device. In some other embodiments, the computer-readable storage medium may alternatively be an external storage device of the computer device, for example, a removable hard disk, a smart media card (SMC), a secure digital (SD) card, or a flash card that is disposed on the computer device. Certainly, the computer-readable storage medium may alternatively include both an internal storage unit of the computer device and an external storage device of the computer device. In the embodiment, the computer-readable storage medium is generally configured to store an operating system and various application software that are installed on the computer device, for example, program code of the video search method in the embodiments. In addition, the computer-readable storage medium may be further configured to temporarily store various types of data that have been output or are to be output.

### Embodiment 5

An embodiment of the application further provides a computer program product, including a computer program. The computer program is executed by a processor to implement the method in the foregoing embodiment.

Clearly, a person skilled in the art should understand that the foregoing modules or steps in the embodiments of the application may be implemented by using a general computer device. The modules or steps may be integrated into a single computer device or distributed in a network including a plurality of computer device. Optionally, the modules or steps may be implemented by using program code that can be executed by the computer device. Therefore, the modules or steps may be stored in a storage apparatus for execution by the computer device. In addition, in some cases, the shown or described steps may be performed in an order different from the order herein. Alternatively, the modules or steps are separately made into integrated circuit modules, or a plurality of modules or steps in the modules or steps are made into a single integrated circuit module for implementation. In this way, a combination of any specific hardware and software is not limited in the embodiments of the application.

It should be noted that the foregoing descriptions are merely preferred embodiments of the application, and are not intended to limit the patent protection scope of the application. Any equivalent structure or equivalent procedure change made based on the content of the specification and the accompanying drawings of the application is directly or indirectly applied to other related technical fields, and shall fall within the patent protection scope of the application.

What is claimed is:

1. A video search method, comprising:
obtaining a query text, and determining a query type based on the query text, wherein the query type comprises an information query or a question query;
when the query type is the information query, determining a plurality of first reference videos based on the query text and metainformation respectively associated with a plurality of videos in a preset video library, and generating a first search result, wherein the first search result comprises the plurality of first reference videos; and
when the query type is the question query, determining a plurality of second reference videos based on the query text, the metainformation associated with various videos in the plurality of videos and text content associated with various videos in the plurality of videos, and generating a second search result based on the query text and the plurality of second reference videos, wherein the second search result comprises a reply text for the query text; and
the text content associated with the videos is obtained by performing a speech recognition on the videos.

2. The method according to claim 1, wherein the determining a plurality of first reference videos based on the query text and metainformation respectively associated with a plurality of videos in a preset video library comprises:
determining similarities between the query text and the metainformation respectively associated with the plurality of videos; and
determining videos whose similarities are greater than a first preset threshold as the first reference videos.

3. The method according to claim 1, before the determining a plurality of second reference videos based on the query text, the metainformation associated with various videos in the plurality of videos, and text content associated with various videos in the plurality of videos, further comprising:
obtaining the metainformation associated with the various videos;
inputting the metainformation into a pre-supervised fine-tuned first large language model, to extract a keyword from the metainformation by using the first large language model, and correcting the keyword;
providing a pre-configured speech recognition system with a corrected keyword as a biasing word; and
performing the speech recognition on the videos based on the biasing word by using the speech recognition system, to obtain the text content.

4. The method according to claim 1, wherein the determining a plurality of second reference videos based on the query text, the metainformation associated with various videos in the plurality of videos, and text content associated with various videos in the plurality of videos comprises:
enhancing the query text by using a pre-trained second large language model to obtain an enhanced query text;
processing the text content of the plurality of videos by using a pre-trained third large language model to generate digest content respectively corresponding to the plurality of videos;
performing a sparse retrieval based on the enhanced query text and the digest content respectively corresponding to the plurality of videos to obtain a first retrieval result, wherein the first retrieval result comprises a video having word matching to the enhanced query text;
performing a dense retrieval based on the enhanced query text and the digest content respectively corresponding to the plurality of videos to obtain a second retrieval result, wherein the second retrieval result comprises a video having semantic matching to the enhanced query text; and
determining the plurality of second reference videos based on the first retrieval result and the second retrieval result.

5. The method according to claim 4, wherein the enhancing the query text by using a pre-trained second large language model to obtain an enhanced query text comprises:
obtaining a historical query text and a historical video watchlist;
inputting the historical query text, the historical video watchlist and the query text into the second large language model, to generate an expanded query word related to the query text by using the second large language model;
combining the expanded query word and the query text to obtain an expanded query text;
performing a tokenization processing on the expanded query text to obtain a plurality of subwords, and assigning a corresponding weight for each subword; and
determining the enhanced query text based on the plurality of subwords and corresponding weights thereof.

6. The method according to claim 4, wherein the performing a sparse retrieval based on the enhanced query text and the digest content respectively corresponding to the plurality of videos to obtain a first retrieval result comprises:
performing an information extraction on the digest content respectively corresponding to the plurality of videos by using a pre-trained fourth large language model to obtain a plurality of target elements, and constructing an inverted index based on the plurality of target elements and the digest content respectively corresponding to the plurality of videos, wherein the inverted index is used to represent digest content corresponding to each target element; and
performing the sparse retrieval based on the inverted index and the enhanced query text to obtain the first retrieval result.

7. The method according to claim 4, wherein the performing a dense retrieval based on the enhanced query text and the digest content respectively corresponding to the plurality of videos to obtain a second retrieval result comprises:
obtaining the metainformation respectively associated with the plurality of videos;
combining the metainformation and the digest content of each video to construct a video index set; and
inputting the video index set and the enhanced query text into a pre-trained semantic recall model, to obtain the second retrieval result by using the semantic recall model.

8. The method according to claim 1, wherein the generating a second search result based on the query text and the plurality of second reference videos comprises:
obtaining text content respectively associated with the plurality of second reference videos, and performing a chunking processing on each text content to obtain a plurality of text content chunks, wherein each text content chunk is associated with video information, and the video information comprises metainformation of a second reference video corresponding to the text content chunk and time information of the text content chunk in the corresponding second reference video;
inputting the plurality of text content chunks and the query text into a pre-trained vector retrieval model, to determine a preset quantity of text content chunks with a highest matching degree to the query text by using the vector retrieval model; and
inputting the query text, the preset quantity of text content chunks, and the video information respectively associated with the text content chunks into a pre-supervised fine-tuned fifth large language model is performed in advance, to obtain the second search result by using the fifth large language model.

9. A computer device, comprising:
at least one processor; and
a memory communicatively connected to the at least one processor, wherein
the memory stores instructions executable by the at least one processor, and the instructions are executed by the at least one processor to enable the at least one processor to perform following steps:
obtaining a query text, and determining a query type based on the query text, wherein the query type comprises an information query or a question query;
when the query type is the information query, determining a plurality of first reference videos based on the query text and metainformation respectively associated with a plurality of videos in a preset video library, and generating a first search result, wherein the first search result comprises the plurality of first reference videos; and
when the query type is the question query, determining a plurality of second reference videos based on the query text, the metainformation associated with various videos in the plurality of videos and text content associated with various videos in the plurality of videos, and generating a second search result based on the query text and the plurality of second reference videos, wherein the second search result comprises a reply text for the query text; and
the text content associated with the videos is obtained by performing a speech recognition on the videos.

10. The computer device according to claim 9, wherein the determining a plurality of first reference videos based on the query text and metainformation respectively associated with a plurality of videos in a preset video library comprises:
determining similarities between the query text and the metainformation respectively associated with the plurality of videos; and
determining videos whose similarities are greater than a first preset threshold as the first reference videos.

11. The computer device according to claim 9, before the determining a plurality of second reference videos based on the query text, the metainformation associated with various videos in the plurality of videos, and text content associated with various videos in the plurality of videos, further comprising:
obtaining the metainformation associated with the various videos;
inputting the metainformation into a pre-supervised fine-tuned first large language model, to extract a keyword from the metainformation by using the first large language model, and correcting the keyword;
providing a pre-configured speech recognition system with a corrected keyword as a biasing word; and
performing the speech recognition on the videos based on the biasing word by using the speech recognition system, to obtain the text content.

12. The computer device according to claim 9, wherein the determining a plurality of second reference videos based on the query text, the metainformation associated with various videos in the plurality of videos, and text content associated with various videos in the plurality of videos comprises:
enhancing the query text by using a pre-trained second large language model to obtain an enhanced query text;
processing the text content of the plurality of videos by using a pre-trained third large language model to generate digest content respectively corresponding to the plurality of videos;
performing a sparse retrieval based on the enhanced query text and the digest content respectively corresponding to the plurality of videos to obtain a first retrieval result, wherein the first retrieval result comprises a video having word matching to the enhanced query text;
performing a dense retrieval based on the enhanced query text and the digest content respectively corresponding to the plurality of videos to obtain a second retrieval result, wherein the second retrieval result comprises a video having semantic matching to the enhanced query text; and
determining the plurality of second reference videos based on the first retrieval result and the second retrieval result.

13. The computer device according to claim 12, wherein the enhancing the query text by using a pre-trained second large language model to obtain an enhanced query text comprises:
obtaining a historical query text and a historical video watchlist;
inputting the historical query text, the historical video watchlist and the query text into the second large language model, to generate an expanded query word related to the query text by using the second large language model;
combining the expanded query word and the query text to obtain an expanded query text;
performing a tokenization processing on the expanded query text to obtain a plurality of subwords, and assigning a corresponding weight for each subword; and
determining the enhanced query text based on the plurality of subwords and corresponding weights thereof.

14. The computer device according to claim 12, wherein the performing a sparse retrieval based on the enhanced query text and the digest content respectively corresponding to the plurality of videos to obtain a first retrieval result comprises:
performing an information extraction on the digest content respectively corresponding to the plurality of videos by using a pre-trained fourth large language model to obtain a plurality of target elements, and constructing an inverted index based on the plurality of target elements and the digest content respectively corresponding to the plurality of videos, wherein the inverted index is used to represent digest content corresponding to each target element; and
performing the sparse retrieval based on the inverted index and the enhanced query text to obtain the first retrieval result.

15. The computer device according to claim 12, wherein the performing a dense retrieval based on the enhanced query text and the digest content respectively corresponding to the plurality of videos to obtain a second retrieval result comprises:
obtaining the metainformation respectively associated with the plurality of videos;
combining the metainformation and the digest content of each video to construct a video index set; and
inputting the video index set and the enhanced query text into a pre-trained semantic recall model, to obtain the second retrieval result by using the semantic recall model.

16. The computer device according to claim 9, wherein the generating a second search result based on the query text and the plurality of second reference videos comprises:
obtaining text content respectively associated with the plurality of second reference videos, and performing a chunking processing on each text content to obtain a plurality of text content chunks, wherein each text content chunk is associated with video information, and the video information comprises metainformation of a second reference video corresponding to the text content chunk and time information of the text content chunk in the corresponding second reference video;
inputting the plurality of text content chunks and the query text into a pre-trained vector retrieval model, to determine a preset quantity of text content chunks with a highest matching degree to the query text by using the vector retrieval model; and
inputting the query text, the preset quantity of text content chunks, and the video information respectively associated with the text content chunks into a pre-supervised fine-tuned fifth large language model is performed in advance, to obtain the second search result by using the fifth large language model.

17. A computer-readable storage medium, wherein the computer-readable storage medium stores computer instructions, and when the computer instructions are executed by a processor, following steps are implemented:
obtaining a query text, and determining a query type based on the query text, wherein the query type comprises an information query or a question query;
when the query type is the information query, determining a plurality of first reference videos based on the query text and metainformation respectively associated with a plurality of videos in a preset video library, and generating a first search result, wherein the first search result comprises the plurality of first reference videos; and
when the query type is the question query, determining a plurality of second reference videos based on the query text, the metainformation associated with various videos in the plurality of videos and text content associated with various videos in the plurality of videos, and generating a second search result based on the query text and the plurality of second reference videos, wherein the second search result comprises a reply text for the query text; and
the text content associated with the videos is obtained by performing a speech recognition on the videos.

18. The computer-readable storage medium according to claim 17, wherein the determining a plurality of first reference videos based on the query text and metainformation respectively associated with a plurality of videos in a preset video library comprises:
determining similarities between the query text and the metainformation respectively associated with the plurality of videos; and
determining videos whose similarities are greater than a first preset threshold as the first reference videos.

19. The computer-readable storage medium according to claim 17, before the determining a plurality of second reference videos based on the query text, the metainformation associated with various videos in the plurality of videos, and text content associated with various videos in the plurality of videos, further comprising:
obtaining the metainformation associated with the various videos;
inputting the metainformation into a pre-supervised fine-tuned first large language model, to extract a keyword from the metainformation by using the first large language model, and correcting the keyword;
providing a pre-configured speech recognition system with a corrected keyword as a biasing word; and
performing the speech recognition on the videos based on the biasing word by using the speech recognition system, to obtain the text content.

20. The computer-readable storage medium according to claim 17, wherein the determining a plurality of second reference videos based on the query text, the metainformation associated with various videos in the plurality of videos, and text content associated with various videos in the plurality of videos comprises:
enhancing the query text by using a pre-trained second large language model to obtain an enhanced query text;
processing the text content of the plurality of videos by using a pre-trained third large language model to generate digest content respectively corresponding to the plurality of videos;
performing a sparse retrieval based on the enhanced query text and the digest content respectively corresponding to the plurality of videos to obtain a first retrieval result, wherein the first retrieval result comprises a video having word matching to the enhanced query text;
performing a dense retrieval based on the enhanced query text and the digest content respectively corresponding to the plurality of videos to obtain a second retrieval result, wherein the second retrieval result comprises a video having semantic matching to the enhanced query text; and
determining the plurality of second reference videos based on the first retrieval result and the second retrieval result.
